(19) United States
(12) Patent Application Publication
(10) Pub. No.: US 2026/0321682 A1
(43) Pub. Date: Oct. 15, 2026

(54) ELECTROCHEMICAL OXYGEN REDUCTION CATALYST

(71) Applicant: TOYOTA JIDOSHA KABUSHIKI KAISHA, Toyota-shi (JP)

(72) Inventors: Keiichi OKUBO, Toyota-shi (JP); Kazuhiro HIRABAYASHI, Toyota-shi (JP)

(73) Assignee: TOYOTA JIDOSHA KABUSHIKI KAISHA, Toyota-shi (JP)

(21) Appl. No.: 19/430,211

(22) Filed: Dec. 22, 2025

(30) Foreign Application Priority Data
Apr. 9, 2025 (JP) 2025-064053

(51) Int. Cl. H01M 4/92; C25B 11/054; C25B 11/065; C25B 11/081

(52) U.S. Cl. CPC H01M 4/926; C25B 11/054; C25B 11/065; C25B 11/081

(57) ABSTRACT

Provided is an electrochemical oxygen reduction catalyst that exhibits both high catalytic activity and high catalytic activity improvement effect. One aspect of the present disclosure relates to the electrochemical oxygen reduction catalyst including: a catalyst metal having oxygen reduction activity supported on mesoporous carbon; and a modification layer that modifies the catalyst metal. Primary particles of the mesoporous carbon have a mode diameter of 700 nm or less, or primary particles of the mesoporous carbon have a median diameter of 750 nm or less. The mesoporous carbon satisfies at least one of predetermined a) a BET specific surface area, b) a mode pore diameter, and c) a total pore volume of pores in a range of 2.0 nm to 30 nm.

### CROSS REFERENCE TO RELATED APPLICATIONS

The present application claims priority from Japanese patent application JP 2025-064053 filed on Apr. 9, 2025, the entire content of which is hereby incorporated by reference into this application.

### BACKGROUND

### Technical Field

The present disclosure relates to an electrochemical oxygen reduction catalyst.

### Background Art

Electrochemical oxygen reduction catalysts are extensively utilized in fuel cells, water electrolysis systems, and metal-air batteries and the like. As electrochemical oxygen reduction catalysts, catalysts are known in which a catalyst metal supported on a carrier is modified with nitrogen-containing organic compounds.

For example, JP 2024-11754 A discloses a catalyst including metal particles having oxygen reduction activity, an additive having a basic functional group, and a binder having an acid functional group, in which the additive is at least one organic nitrogen compound and the ratio of the total amount of base functional groups of the additive to the total amount of acid functional groups of the binder (amount of salt point/amount of acid point) is greater than 0 and equal to or less than 6.82. JP 2024-11754 A discloses that the metal particles may be supported on a carrier.

Also, J P 2024-16321 A discloses a catalyst including metal particles exhibiting oxygen reduction activity, a carrier, and an additive, in which the metal particles are supported on the carrier, the additive is at least one organic nitrogen compound, and the BET specific surface area of the carrier is 641 m² g⁻¹ₛᵤₚₚₒᵣₜ or less.

As described above, it is known that the electrochemical oxygen reduction catalysts include catalyst metals supported on carriers. In conventional catalysts, the catalytic activity might not be sufficiently improved by modifying the catalyst metal with additives, depending on the type of carrier used, and achieving sufficient catalytic activity improvement effect may be challenging. The present disclosure provides the electrochemical oxygen reduction catalysts that exhibit both high catalytic activity and high catalytic activity improvement effect.

The present inventors discovered that controlling the properties of mesoporous carbon carriers enhances the catalytic activity and the catalytic activity improvement effect and results in the improved catalytic performance.

### SUMMARY

In other words, the present disclosure includes the following aspects and embodiments.

(Embodiment 1) An electrochemical oxygen reduction catalyst comprising:
a catalyst metal having oxygen reduction activity supported on mesoporous carbon;
and a modification layer that modifies the catalyst metal, wherein primary particles of the mesoporous carbon have a mode diameter of 700 nm or less,
the mesoporous carbon satisfies at least one of a) to c) below:
a) a BET specific surface area exceeds 641 m² g⁻¹;
b) a mode pore diameter is smaller than 7.7 nm; and
c) a total pore volume of pores in a range of 2.0 nm to 30 nm is greater than 6.50 mL g⁻¹.

(Embodiment 2) The electrochemical oxygen reduction catalyst according to Embodiment 1, wherein the primary particles of the mesoporous carbon have a mode diameter of 300 nm or less.

(Embodiment 3) An electrochemical oxygen reduction catalyst comprising:
a catalyst metal having oxygen reduction activity supported on mesoporous carbon; and a modification layer that modifies the catalyst metal,
wherein primary particles of the mesoporous carbon have a median diameter of 750 nm or less,
the mesoporous carbon satisfies at least one of a) to c) below,
a) a BET specific surface area exceeds 641 m² g⁻¹;
b) a mode pore diameter is smaller than 7.7 nm; and
c) a total pore volume of pores in a range of 2.0 nm to 30 nm is greater than 6.50 mL g⁻¹.

(Embodiment 4) The electrochemical oxygen reduction catalyst according to Embodiment 3,
wherein the primary particles of the mesoporous carbon have a median diameter of 400 nm or less.

(Embodiment 5) The electrochemical oxygen reduction catalyst according to any one of Embodiments 1 to 4,
wherein the catalyst metal is platinum, a platinum alloy, or a platinum-containing composite, and the modification layer contains a nitrogen-containing cyclic organic compound or a polymer thereof, or a cation thereof.

The present disclosure allows providing the electrochemical oxygen reduction catalysts that exhibit the high catalytic activity and the high catalytic activity improvement effect.

### BRIEF DESCRIPTION OF THE DRAWINGS

FIG. 1 is a graph illustrating a relationship between a mode diameter of primary particles of a carbon carrier and a mass activity improvement factor of a catalyst; and

FIG. 2 is a graph illustrating a relationship between a median diameter of the primary particles of the carbon carrier and the mass activity improvement factor of the catalyst.

### DETAILED DESCRIPTION

The following provides a detailed description of an embodiment of the disclosure.

### <Electrochemical Oxygen Reduction Catalyst>

One aspect of the disclosure relates to electrochemical oxygen reduction catalysts. The electrochemical oxygen reduction catalyst of this aspect (hereinafter referred to as “the catalyst of this aspect”) includes a catalyst metal with oxygen reduction activity supported on mesoporous carbon and a modification layer that modifies the catalyst metal. In other words, the catalyst of this aspect includes a mesoporous carbon carrier, a catalyst metal having oxygen reduction activity, and a modification layer.

In a first embodiment of the catalyst of this aspect, primary particles of the mesoporous carbon have a mode diameter of 700 nm or less.

In a second embodiment of the catalyst of this aspect, primary particles of the mesoporous carbon have a median diameter of 750 nm or less.

Configurations of the first embodiment and the second embodiment of the catalyst of this aspect are described below.

In the catalyst of this aspect, the catalyst metal may be any metal having oxygen reduction activity (oxygen reduction catalytic activity). Catalyst metals include, for example, platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, yttrium, and other metals. The catalyst metal may include the metals exemplified above either individually or as an alloy including two or more of them. The catalyst metal may be an oxide, nitride, sulfide, or phosphide of the metals exemplified above. The catalyst metal is platinum, a platinum alloy, or a composite containing platinum in some embodiments. In the case of platinum alloys and platinum-containing composites, metals other than platinum, such as ruthenium, iridium, and cobalt, may be used. When the catalyst metal is a platinum alloy or a composite containing platinum, the content of metals other than platinum is typically in the range of 0.11 to 60 atomic percent with respect to the total mass of the catalyst metal.

The loading ratio of the catalyst metal is typically in the range of 1 to 70 mass % relative to the mass of the mesoporous carbon, and for example, it is in the range of 18 to 48 mass %.

The particle diameter (particle size) of catalyst metal particles typically ranges from 1 nm to 100 nm.

In the catalyst of this aspect, the composition and content of catalyst metals can be determined, for example, by analysis using thermogravimetric analysis (TG) or inductively coupled plasma optical emission spectroscopy (ICP).

In the catalyst of this aspect, the particle diameter of the catalyst metal can be determined, for example, by measuring the crystallite diameter using an X-ray diffraction method and calculating the average crystallite diameter. Alternatively, the particle diameter of the catalyst metal particles may be determined by measuring the particle diameter of 100 to 1000 catalyst metal particles using an electron microscope and calculating the average of these measurements (mean particle diameter).

In the catalyst of this aspect, the catalyst metal is supported on a mesoporous carbon (carbon carrier). In this disclosure, the mesoporous carbon refers to a carbon having pores. In the catalyst of this aspect, the catalyst metal is typically supported within the pores of the mesoporous carbon and may also be supported on the surface of the mesoporous carbon. In one embodiment, the catalyst metal is supported within the pores of the mesoporous carbon as well as on its surface.

Conventional methods can be employed to support catalyst metals on the mesoporous carbon. For example, a mesoporous carbon dispersion obtained by dispersing mesoporous carbon is mixed with a catalyst metal, filtered, washed, redispersed in ethanol or the like, and then dried using a vacuum pump or the like. After drying, the product may undergo heat treatment if necessary.

In the catalyst of this aspect, the mesoporous carbon includes primary particles having pores. The primary particles are the smallest units of particles that cannot be further divided. The mesoporous carbon may include primary particles with pores, and when the mesoporous carbon includes such primary particles, it may also include secondary particles that are aggregates of them. The presence of pores in the primary particles can be confirmed, for example, through observation using an electron microscope.

In the first embodiment of the catalyst of this aspect, the primary particles of the mesoporous carbon have a mode diameter of 700 nm or less. When the catalyst metal is supported within the pores of the carrier, the distance from the carrier surface to the catalyst metal increases. This makes it challenging to modify the catalyst metal with a modification layer containing additives, thereby hindering the catalytic activity improvement effect. When the mode diameter of the primary particles of the mesoporous carbon is 700 nm or less, the catalyst metal can be more easily modified with the modification layer, resulting in the enhanced catalytic activity improvement effect. The mode diameter of the primary particles of the mesoporous carbon may be 300 nm or less, 100 nm or less, or 50 nm or less. When the mode diameter of the primary particles of the mesoporous carbon is within this range, the catalytic activity improvement effect is further enhanced. The lower limit of the mode diameter of the primary particles of the mesoporous carbon is not particularly limited, and may be, for example, 5 nm or more, 10 nm or more, or 20 nm or more. The mode diameter of the primary particles of the mesoporous carbon is, for example, from 5 nm to 700 nm, and may be from 10 nm to 300 nm. The mode diameter of the primary particles of the mesoporous carbon is defined as the particle diameter corresponding to the highest peak (also referred to as the peak diameter) in the particle size distribution (on number basis) obtained by the measurement method described below.

In the second embodiment of the catalyst of this aspect, the primary particles of the mesoporous carbon have a median diameter of 750 nm or less. When the median diameter of the primary particles of the mesoporous carbon is 750 nm or less, the catalyst metal can be more easily modified with the modification layer, resulting in the enhanced catalytic activity improvement effect. The median diameter of the primary particles of the mesoporous carbon may be 400 nm or less, 350 nm or less, or 80 nm or less. When the median diameter of the primary particles of the mesoporous carbon is within this range, the catalytic activity improvement effect is further enhanced. The lower limit of the median diameter of the primary particles of the mesoporous carbon is not particularly limited and may be, for example, 5 nm or more, 10 nm or more or 20 nm or more. The median diameter of the primary particles of the mesoporous carbon is, for example, from 5 nm to 750 nm, and may be from 10 nm to 400 nm. The median diameter of the primary particles of the mesoporous carbon refers to the particle diameter at 50% cumulative distribution (also referred to as D50) in the particle size distribution (on number basis) obtained by the measurement method described below.

The mode diameter and the median diameter of the primary particles of the mesoporous carbon can be measured using, for example, a transmission electron microscope (TEM), a scanning electron microscope (SEM), a laser diffraction method, a light scattering method, a dynamic light scattering method (DLS), a centrifugal sedimentation method, a particle track analysis method (PTA), or the like. A combination of these measurement methods can be employed. For example, the particle diameter of 100 to 1000 primary particles of the mesoporous carbon may be measured using the transmission electron microscope (TEM) or the scanning electron microscope (SEM). The mode diameter and the median diameter of the obtained particle size distribution can then be used as the mode diameter and the median diameter of the primary particles of the mesoporous carbon, respectively. In one embodiment, the mode diameter and the median diameter of the primary particles of the mesoporous carbon can be measured using the transmission electron microscope (TEM) and the laser diffraction method.

In one embodiment, the mesoporous carbon may have both the mode diameter of the primary particles as described in the first embodiment and the median diameter of the primary particles as described in the second embodiment. That is, in one embodiment, the mesoporous carbon has a primary particle mode diameter of 700 nm or less and a primary particle median diameter of 750 nm or less.

In the catalyst of this aspect, the mesoporous carbon satisfies at least one of a) to c) below:
a) a BET specific surface area exceeds 641 m² g⁻¹;
b) a mode pore diameter is smaller than 7.7 nm; and
c) a total pore volume of pores in the range of 2.0 nm to 30 nm is greater than 6.50 mL g⁻¹. The mesoporous carbon may satisfy one, two, or three of the above a) to c), and may satisfy two or three of the above a) to c), and in one embodiment, may satisfy three (all) of the above a) to c).

Regarding a) above, the mesoporous carbon may have a BET specific surface area exceeding 641 m² g⁻¹ and may exceed 650 m² g⁻¹. In the catalyst of this aspect, when the BET specific surface area of the mesoporous carbon is within the specified range, the catalytic activity is enhanced. The BET specific surface area is the value based on the mass of the mesoporous carbon (m² g⁻¹_{mesoporous carbon}).

Regarding b) above, the mesoporous carbon may have a mode pore diameter of smaller than 7.7 nm and may be smaller than 7.0 nm. In the catalyst of this aspect, the catalytic activity is enhanced when the mode pore diameter of the mesoporous carbon falls within this range. The pore diameter refers to the diameter of the pores. The mode pore diameter of the mesoporous carbon refers to the pore diameter corresponding to the highest peak (also referred to as the peak pore diameter) in the pore size distribution curve obtained by the measurement method described below.

Regarding c) above, the mesoporous carbon may have a total pore volume of pores in the range of 2.0 nm to 30 nm, which is greater than 6.50 mL g⁻¹ and may be greater than 7.0 mL g⁻¹. In the catalyst of this aspect, when the total pore volume of the mesoporous carbon is within the specified range, the catalytic activity is enhanced. The above-described total pore volume refers to the total pore volume of pores with pore diameters in the range of 2.0 nm to 30 nm (mL g⁻¹_{mesoporous carbon}), based on the mass of the mesoporous carbon.

For each physical property value of the mesoporous carbon (carrier), the value may be measured directly from the carrier itself, or it may be measured from the catalyst metal-supported carrier and then converted to the mass of the carrier. The BET specific surface area, the mode pore diameter, and the total pore volume of pores in the range of 2.0 nm to 30 nm can be measured using the N₂ adsorption/desorption method. The three parameters described above can be determined from the dependence of the amount of N₂ adsorption on the sample with respect to relative pressure. The calculation of the specific surface area is based on BET theory. The evaluation method is not limited to the above methods, but may also include the Hg porosimetry method, the H₂O adsorption method, the DBP oil absorption method using dibutyl phthalate, or the like. Microscopic observation or other methods may also be employed.

In the catalyst of this aspect, the content of the mesoporous carbon can be determined, for example, using the thermogravimetric analysis (TG) or the inductively coupled plasma optical emission spectroscopy (ICP).

In the catalyst of this aspect, the modification layer may include nitrogen-containing cyclic organic compounds, their polymers, or their cations. In the catalyst of this aspect, the electrochemical oxygen reduction reaction is promoted by modifying the catalyst metal with a modification layer containing an additive (modifier), where the additive is a nitrogen-containing cyclic organic compound, its polymer, or its cation.

In the catalyst of this aspect, the nitrogen-containing cyclic organic compounds may include, for example, compounds having 3- to 20-membered rings or 3- to 10-membered rings, with 1, 2, 3, 4, or 5 nitrogen atoms in the ring, or compounds with 5- or 6-membered rings. The nitrogen-containing cyclic organic compounds may be monocyclic or polycyclic compounds. When the nitrogen-containing cyclic organic compound is a polycyclic compound, it is sufficient that at least one of the rings contain a nitrogen atom. The nitrogen-containing cyclic organic compounds include, but are not limited to, piperidine, piperazine, morpholine, quinuclidine, pyrrolidine, azetidine, azetidine-2-one, aziridine, tropane, pyrrole, imidazole, pyrazole, oxazole, isoxazole, thiazole, isothiazole, pyridine, pyrimidine, pyridazine, pyrazine, triazine, quinoline, isoquinoline, quinazoline, phthalazine, pteridine, 1,4-benzodiazepine, indole, benzimidazole, purine, acridine, phenoxazine, phenothiazine, and their derivatives, as well as organic compounds containing any of these skeletons. In one embodiment, the nitrogen-containing cyclic organic compound is a compound with a triazine skeleton (1,2,3-triazine, 1,2,4-triazine, or 1,3,5-triazine) from the perspective of durability.

In one embodiment, the nitrogen-containing cyclic organic compound, its polymer, or its cation is a compound represented by general formula (1), a polymer having the compound as a monomer, or a cation thereof.

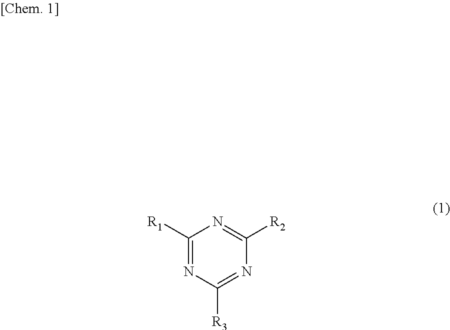

(In formula (1), R₁, R₂, and R₃ each independently represent one functional group selected from the group consisting of a hydrogen atom, a halogen atom, a nitrile group, an amide group, an imine group, an amino group, a thiol group, a hydroxyl group, a sulfo group, a carboxylic acid group, a phosphate group, a ketone group, an aldehyde group, an ester group, an alkoxy group, a phenolic group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, an alkyl group having 1 to 10 carbon atoms, an alkenylamino group having 2 to 10 carbon atoms, an alkenylsulfonic acid group having 2 to 10 carbon atoms, a perfluoroalkenyl group having 2 to 10 carbon atoms, or an alkenyl group having 2 to 10 carbon atoms. Each of these functional groups may have, in its molecular chain, at least one selected from the group consisting of at least one functional group selected from the above-described functional groups, an aromatic ring, a hetero ring, an oxygen atom, a sulfur atom, a nitrogen atom, a fluorine atom, a chlorine atom, a bromine atom, an iodine atom, and a hydrogen atom.)

The nitrogen-containing cyclic organic compounds, their polymers, or their cations (hereinafter also referred to as “nitrogen-containing cyclic organic compounds and the like”) may be melamine (1,3,5-triazine-2,4,6-triamine), ammeline, ammelide, cyanuric acid, thiocyanuric acid, triazine (1,2,3-triazine, 1,2,4-triazine, or 1,3,5-triazine) or their derivatives, or their polymers, or their cations. Additionally, the nitrogen-containing cyclic organic compounds and the like may be 2,4,6-tris [bis(methoxymethyl)amino]-1,3,5-triazine, 6-(dibutylamino)-1,3,5-triazine-2,4-dithiol, 2,4-diamino-6-butylamino-1,3,5-triazine, or 2,4,6-tris(pentafluoroethyl)-1,3,5-triazine, or polymers using any of these as monomers, or copolymers such as melamine-formaldehyde copolymers, for example, methylated poly(melamine-co-formaldehyde) or isobutylated poly(melamine-co-formaldehyde), or cations thereof. In one embodiment, the nitrogen-containing cyclic organic compound or the like is melamine, a derivative thereof, a polymer thereof, or a cation thereof.

The content of the modification layer is typically in the range of 0.001 to 0.1 as a mass ratio relative to the mass of the catalyst metal in the catalyst of this aspect.

The composition and the content of the nitrogen-containing cyclic organic compounds, their polymers, or their cations in the modification layer can be determined, for example, by dissolving and extracting the modification layer in the catalyst of this aspect and analyzing the components in the extract using elemental analysis, various chromatography techniques, an UV-visible spectroscopy (UV-Vis), an infrared spectroscopy (IR), or a nuclear magnetic resonance (NMR).

In the catalyst of this aspect, the modification layer is typically located on the surface of the catalyst metal, for example, covering the surface of the catalyst metal. The modification rate by the modification layer on the surface of the catalyst metal may be equal to or greater than 8 area %, equal to or greater than 11 area %, equal to or greater than 12 area %, or equal to or greater than 20 area % of the total surface area of the catalyst metal. A modification rate of 8 area % or more leads to the enhanced catalytic activity improvement effect. The upper limit of the modification rate by the modification layer on the surface of the catalyst metal is not particularly limited, but for example, it may be equal to or less than 50 area %, equal to or less than 40 area %, or equal to or less than 30 area %. The modification rate by the modification layer on the surface of the catalyst metal is defined as a percentage of the surface area of the catalyst metal that is modified with the modification layer relative to the total surface area of the catalyst metal. The modification rate by the modification layer on the surface of the catalyst metal can be determined, for example, by the method described in the example.

The catalyst of this aspect may include a binder. The binder is typically a polyelectrolyte (ionomer) containing ion exchange groups. Examples of the ion exchange groups in the polyelectrolytes include sulfonic acid groups and phosphate groups. The binder is, for example, a perfluorocarbon sulfonic acid polymer.

### <Electrochemical Oxygen Reduction Catalyst Applications>

One aspect of the disclosure relates to fuel cells. A fuel cell of this aspect includes at least a cathode electrode catalyst layer, an anode electrode catalyst layer, and an electrolyte membrane disposed between the cathode electrode catalyst layer and the anode electrode catalyst layer, in which the cathode electrode catalyst layer includes an electrochemical oxygen reduction catalyst of one aspect of the disclosure.

Another one aspect of the disclosure relates to water electrolysis systems. The water electrolysis system of this aspect includes at least a cathode electrode catalyst layer, an anode electrode catalyst layer, an electrolyte membrane disposed between the cathode electrode catalyst layer and the anode electrode catalyst layer, and a water supply, in which the anode electrode catalyst layer includes an electrochemical oxygen reduction catalyst of one aspect of the disclosure.

Another one aspect of the disclosure relates to metal-air batteries. The metal-air battery of this aspect includes at least a cathode electrode catalyst layer, an anode metal layer, and an electrolyte membrane disposed between the cathode electrode catalyst layer and the anode metal layer, in which the cathode electrode catalyst layer includes an electrochemical oxygen reduction catalyst of one aspect of the disclosure.

### <Manufacturing Method for Electrochemical Oxygen Reduction Catalyst>

Another one aspect of the disclosure relates to the manufacturing methods for the electrochemical oxygen reduction catalysts of one aspect of the disclosure. The method of this aspect includes a modification step. The method of this aspect may optionally include a preparation step and an electrode catalyst layer formation step.

### [Preparation Step]

This step involves preparing a mesoporous carbon (carrier), a catalyst metal, and an additive. This step typically also involves preparing the binder. Additionally, this step may involve the preparation of additional materials, such as solvents and substrates, as needed. Each material prepared in this step should exhibit the characteristics described above. In this step, each material may be prepared by synthesizing it to have predetermined characteristics, or may be prepared by purchasing or otherwise obtaining commercially available products. The catalyst metals can be supported on the mesoporous carbon using a conventional method. The catalyst metal can be loaded onto the mesoporous carbon by mixing the mesoporous carbon, the catalyst metal, and the additive during a subsequent modification step.

### [Modification Step]

This step involves mixing a catalyst metal supported on the mesoporous carbon with an additive, and modifying the catalyst metal with a modification layer containing the additive. In this step, the binder may also, as desired, be mixed together with the catalyst metal and the additive. In this step, the catalyst metal supported on the mesoporous carbon is typically mixed with the additive and, optionally, the binder, in the presence of a solvent. As the solvent, it is not particularly limited, and examples include water and alcohols (for example, 2-propanol), as well as one or more mixtures thereof.

In this step, the electrochemical oxygen reduction catalyst of one aspect of the disclosure can be obtained by removing the solvent from the resulting mixture.

Alternatively, if the electrode catalyst layer formation step described below is performed, the mixture obtained in this step can be utilized, in the electrode catalyst layer formation step, as a catalyst ink containing the electrochemical oxygen reduction catalyst of one aspect of the disclosure. In this case, the mixture obtained in this step may be used as is or with the addition of further solvents as exemplified above.

### [Electrode Catalyst Layer Formation Step]

This step involves coating a surface of a substrate with a catalyst ink that contains the electrochemical oxygen reduction catalyst obtained through the modification step. In this step, the solvent is typically removed from the catalyst ink after it has been applied.

The substrate used in this step is not particularly limited and may include materials such as polytetrafluoroethylene (PTFE), electrolyte membranes containing ion exchange groups, carbon fiber, and metal fiber.

By performing this step, the electrochemical oxygen reduction catalyst of one aspect of the disclosure can be obtained in a form disposed on the surface of the substrate (electrode catalyst layer). In this case, the thickness of the electrode catalyst layer is typically in the range of 5 to 30 μm. The content of the catalyst metal in the electrode catalyst layer is typically in the range of 0.1 to 0.6 mg/cm², as the mass based on the total area of the electrode catalyst layer.

### EXAMPLES

The following examples will further illustrate the present disclosure. However, the technical scope of the disclosure is not limited to these embodiments.

### <Production of Electrochemical Oxygen Reduction Catalyst>

### Examples 1 to 7 and Comparative Examples 1 to 7

The mesoporous carbon (carbon carrier) with various properties as shown in Table 1 were prepared. The BET specific surface area, the mode pore diameter, and the total pore volume of pores in the range of 2.0 nm to 30 nm of the carbon carriers were measured as described above. The mode diameter and the median diameter of the primary particles of the carbon carrier are measured on number basis using a transmission electron microscope (TEM) and a laser diffraction method.

Platinum particle supporting carriers were prepared by supporting platinum particles on individual carbon carriers.

The above-described platinum particle supporting carrier, melamine (additive), a perfluorocarbon sulfonic acid polymer (based on Nafion, manufactured by Chemours, EW: 1100), and a mixture of 2-propanol and ultrapure water were placed into a vessel in predetermined amounts, mixed, and stirred to prepare a catalyst ink containing an electrochemical oxygen reduction catalyst. In electrochemical oxygen reduction catalysts, platinum particles were modified with a modification layer containing melamine.

### <Evaluation of Electrochemical Oxygen Reduction Catalysts>

### [Catalytic Performance]

The catalytic performance was evaluated based on the catalyst mass activity (A g⁻¹) measured at a potential of 0.9 V (vs. the reversible hydrogen electrode (RHE)). The catalyst mass activity is defined as the current per unit mass of metal particles. A higher value indicates a higher catalyst activity.

The catalyst ink was deposited onto a glassy carbon rotating electrode (5 mm in diameter, manufactured by Hokuto Denko Co., Ltd.) such that the loading of the carbon carrier was 20 μg cm⁻², and then dried to form an electrode with a catalyst layer on its surface.

The electrochemical measurements were conducted using a three-electrode system, where the prepared electrode served as a working electrode, the reversible hydrogen electrode was used as a reference electrode, and a carbon rod functioned as the counter electrode. The electrochemical measurements were conducted using a rotating disk electrode (RDE) method. A perchloric acid solution adjusted to a concentration of 0.1 M using ultrapure water was employed as the electrolyte. After performing a cyclic voltammetry in an inert gas atmosphere, the gas atmosphere was switched to oxygen, and a linear sweep voltammetry was conducted starting from a low potential side. The rotation speed of the electrode was varied to 400, 900, 1600, 2000, 2500, and 3600 rpm, and the linear sweep voltammetry measurements were conducted repeatedly. From the obtained potential-current characteristics, a Koutecký-Levich plot was created to calculate the catalyst mass activity (A g⁻¹) at 0.9 V (vs. the reversible hydrogen electrode (RHE)). The ratio of the improvement in the catalyst mass activity value due to modification with a modification layer containing an additive (mass activity improvement factor) was calculated using the following formula: (catalyst mass activity value after the introduction of the additive)/(catalyst mass activity value before the introduction of the additive). The cell potential (cell voltage) at a current density of 0.2 A cm⁻² was obtained from the potential-current characteristics.

### [Surface Modification Rate]

For the electrochemical oxygen reduction catalyst, the rate of the surface area of the platinum particles modified by the modification layer with respect to the total surface area of the platinum particles (surface modification rate) was determined using the hydrogen adsorption current value of the reduction wave in the cyclic voltammogram.

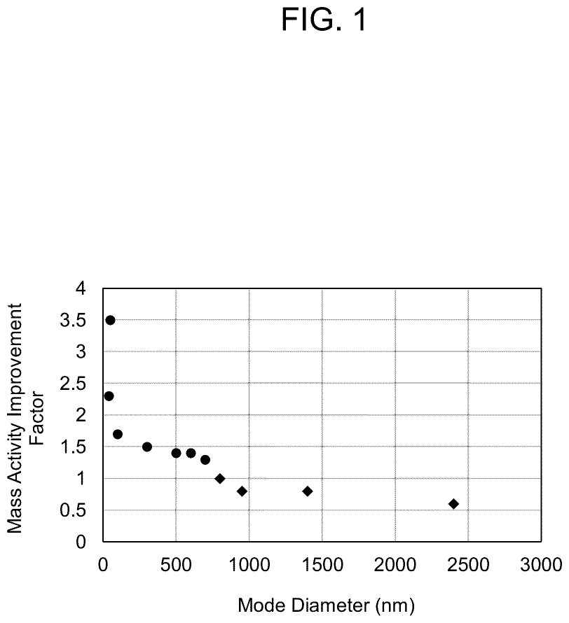

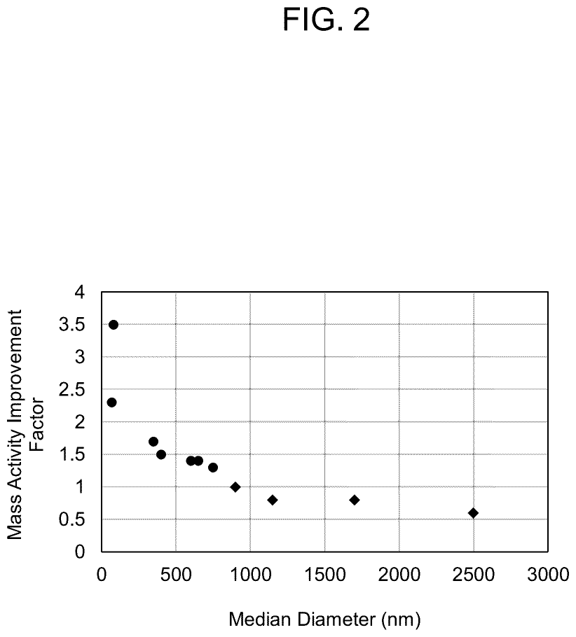

Table 1 presents the properties of the carbon carrier and the results of catalyst evaluation for Examples 1-7 and Comparative Examples 1-7. FIG. 1 illustrates the relationship between the mode diameter of the primary particles of the carbon carrier and the mass activity improvement factor of the catalysts in Examples 1-7 and Comparative Examples 1-4. FIG. 2 illustrates the relationship between the median diameter of the primary particles of the carbon carrier and the mass activity improvement factor of the catalyst for the catalysts described in Examples 1-7 and Comparative Examples 1-4.

TABLE 1

| | | | | | | Evaluation Result | | |
|---|---|---|---|---|---|---|---|---|
| | Carbon Carrier | | | | | Surface | Mass Activity | |
| | BET Specific | Mode Pore | 2.0 to 30 mm | Primary Particle | Primary Particle | Modification | Improvement | Cell |
| | Surface Area | Diameter | Total Pore Volume | Median Diameter | Mode Diameter | Rate | Factor | Voltage |
| | m² g⁻¹ | nm | mL g⁻¹ | nm | nm | % | — | mV |
| Ex. 1 | Over 641 | Less Than 7.7 | Over 6.50 | 70 | 40 | 22 | 2.3 | 910 |
| Ex. 2 | Over 641 | Less Than 7.7 | Over 6.50 | 80 | 50 | 20 | 3.5 | 924 |
| Ex. 3 | Over 641 | Less Than 7.7 | Over 6.50 | 350 | 100 | 12 | 1.7 | 900 |
| Ex. 4 | Over 641 | Less Than 7.7 | Over 6.50 | 400 | 300 | 11 | 1.5 | 896 |
| Ex. 5 | Over 641 | Less Than 7.7 | Over 6.50 | 600 | 500 | 9 | 1.4 | 893 |
| Ex. 6 | Over 641 | Less Than 7.7 | Over 6.50 | 650 | 600 | 8 | 1.4 | 893 |
| Ex. 7 | Over 641 | Less Than 7.7 | Over 6.50 | 750 | 700 | 8 | 1.3 | 891 |
| Comp. Ex. 1 | Over 641 | Less Than 7.7 | Over 6.50 | 900 | 800 | 5 | 1.0 | 882 |
| Comp. Ex. 2 | Over 641 | Less Than 7.7 | Over 6.50 | 1150 | 950 | 3 | 0.8 | 875 |
| Comp. Ex. 3 | Over 641 | Less Than 7.7 | Over 6.50 | 1700 | 1400 | 3 | 0.8 | 875 |
| Comp. Ex. 4 | Over 641 | Less Than 7.7 | Over 6.50 | 2500 | 2400 | 3 | 0.6 | 865 |
| Comp. Ex. 5 | 641 or Less | 7.7 or More | 6.50 or Less | 50 | 30 | 23 | 2.7 | 877 |
| Comp. Ex. 6 | 641 or Less | 7.7 or More | 6.50 or Less | 80 | 50 | 22 | 2.6 | 876 |
| Comp. Ex. 7 | 641 or Less | 7.7 or More | 6.50 or Less | 900 | 900 | 22 | 2.5 | 875 |

Ex.: Example;
Comp. Ex.: Comparative Example

As shown in Table 1 (Examples 1-7 and Comparative Examples 1-4), it can be observed that the smaller the mode diameter and median diameter of the primary particles of the carbon carrier, the higher the surface modification rate.

As shown in Table 1 and FIG. 1, the smaller the mode diameter of the primary particles of the carbon carrier, the greater the mass activity improvement factor. In particular, the catalysts in Examples 1-7, where the mode diameter of the primary particles of the carbon carrier is 700 nm or less, exhibited a mass activity improvement factor greater than 1.0. This indicates that these catalysts demonstrated the high catalytic activity improvement effect compared with the catalysts in Comparative Examples 1-4, where the mode diameter of the primary particles of the carbon carrier is greater than 700 nm.

As shown in Table 1 and FIG. 2, it is observed that the smaller the median diameter of the primary particles of the carbon carrier, the greater the mass activity improvement factor. In particular, the catalysts in Examples 1-7, where the median diameter of the primary particles of the carbon carrier is 750 nm or less, exhibited a mass activity improvement factor greater than 1.0, indicating the high catalytic activity improvement effect compared with the catalysts in Comparative Examples 1-4, where the median diameter of the primary particles of the carbon carrier is greater than 750 nm.

The catalysts in Comparative Examples 5-7 have a BET specific surface area, a mode pore diameter, and a total pore volume of pores in the range of 2.0 nm to 30 nm of the carbon carrier, which are outside the range of values specified for electrochemical oxygen reduction catalysts in one aspect of the disclosure. As shown in Table 1, the catalysts of Comparative Examples 5 to 7 exhibited low cell voltage and low catalytic activity, despite having a high mass activity improvement factor.

The disclosure is not limited to the above-described examples but encompasses various modifications. For example, the above examples are described in detail to illustrate the disclosure in an easily understandable manner, and are not necessarily limited to those having all the described configurations. It is also possible to add, delete, or substitute other configurations for some of the configurations in each embodiment.

All publications, patents, and patent applications cited herein are incorporated herein by reference in their entirety.

What is claimed is:

1. An electrochemical oxygen reduction catalyst comprising:
a catalyst metal having oxygen reduction activity supported on mesoporous carbon; and
a modification layer that modifies the catalyst metal,
wherein primary particles of the mesoporous carbon have a mode diameter of 700 nm or less,
wherein the mesoporous carbon satisfies at least one of a) to c) below,
a) a BET specific surface area exceeds 641 m² g⁻¹;
b) a mode pore diameter is smaller than 7.7 nm; and
c) a total pore volume of pores in a range of 2.0 nm to 30 nm is greater than 6.50 mL g⁻¹.

2. The electrochemical oxygen reduction catalyst according to claim 1,
wherein the primary particles of the mesoporous carbon have a mode diameter of 300 nm or less.

3. An electrochemical oxygen reduction catalyst comprising:
a catalyst metal having oxygen reduction activity supported on mesoporous carbon; and
a modification layer that modifies the catalyst metal,
wherein primary particles of the mesoporous carbon have a median diameter of 750 nm or less,
wherein the mesoporous carbon satisfies at least one of a) to c) below,
a) a BET specific surface area exceeds 641 m² g⁻¹;
b) a mode pore diameter is smaller than 7.7 nm; and
c) a total pore volume of pores in a range of 2.0 nm to 30 nm is greater than 6.50 mL g⁻¹.

4. The electrochemical oxygen reduction catalyst according to claim 3,
wherein the primary particles of the mesoporous carbon have a median diameter of 400 nm or less.

5. The electrochemical oxygen reduction catalyst according to claim 1,
wherein the catalyst metal is platinum, a platinum alloy, or a platinum-containing composite, and the modification layer contains a nitrogen-containing cyclic organic compound or a polymer thereof, or a cation thereof.
